(19) United States
(12) Patent Application Publication
(10) Pub. No.: US 2026/0311951 A1
(43) Pub. Date: Oct. 8, 2026

(54) X-RAY DEVICES WITH NANOTUBE EMITTERS AND METHODS OF FORMING

(71) Applicant: VAREX IMAGING CORPORATION, Salt Lake City, UT (US)

(72) Inventors: Benjamin Vandyke, Salt Lake City, UT (US); Jake Riggle, Bountiful, UT (US); Vance Scott Robinson, South Jordan, UT (US); Scott Olsen, Lehi, UT (US)

(73) Assignee: VAREX IMAGING CORPORATION, Salt Lake City, UT (US)

(21) Appl. No.: 19/480,141

(22) PCT Filed: Sep. 27, 2024
(86) PCT No.: PCT/US2024/048948

§ 371 Date: Oct. 30, 2025

Related U.S. Application Data
(60) Provisional application No. 63/587,053, filed on Sep. 29, 2023.

(51) Int. Cl. H01J 35/06; H01J 9/02

(52) U.S. Cl. CPC H01J 35/065; H01J 9/022; H01J 35/066; H01J 2201/30434; H01J 2235/062; H01J 2235/068

(57) ABSTRACT

Some embodiments include a method, comprising: providing a substrate including a nanotube layer including nanotubes; heating the nanotube layer; and disrupting at least part of the nanotube layer due to the heating such that nanotubes in the at least part of the nanotube layer are activated for electron emission. Other embodiments include an x-ray device including a substrate including nanotubes formed by the method.

### CROSS-REFERENCE TO RELATED APPLICATIONS

This application claims priority from and is a national stage application under 35 USC 371 of International Application No. PCT/US2024/048948, filed 27 Sep. 2024, which claims priority to U.S. Provisional Patent Application No. 63/587,053, filed 29 Sep. 2023, the entire disclosures of which are hereby incorporated by reference.

### FIELD

X-ray devices may use nanotube (NT) structures as part of a field emitter configured to generate electrons. In some instances, the nanotube structures must be processed to activate the nanotubes so that the nanotubes may emit electrons under operating conditions. Some mechanical activation techniques may be used such as adhesive tape removal, rubber rollers, or other adhesives.

### BRIEF DESCRIPTION OF SEVERAL VIEWS OF THE DRAWINGS

FIGS. 1A-1C are block diagrams of operations to form an activated nanotube substrate according to some embodiments.

FIGS. 2A-2C are block diagrams of operations to form an activated nanotube substrate with unactivated regions according to some embodiments.

FIG. 3A-3C are block diagrams of activated regions on an activated nanotube substrate according to some embodiments.

FIG. 3D is an image of nanotubes on a substrate according to some embodiments.

FIGS. 4A-4B are block diagrams of operations to form an activated nanotube substrate formed using a mask according to some embodiments.

FIG. 5 is a block diagram of a relationship of an activated nanotube substrate and a mask according to some embodiments.

FIG. 6 is a block diagram of an x-ray device with an activated nanotube substrate, a mask according to some embodiments.

FIG. 7 is a block diagram of an x-ray imaging system according to some embodiments.

### DETAILED DESCRIPTION

Embodiments include x-ray devices with nanotube emitters and methods of forming. Processes for forming activated nanotube emitters may include depositing carbon nanotubes on a substrate. Various techniques such as screen printing, spray coating, electrophoretic deposition, or the like may be used to deposit the nanotubes. Further processing is performed using a mechanical process, such as using adhesive tape, is used to expose nanotubes so that they are activated for emission of electrons. Embodiments described herein provide alternative techniques to activate the nanotubes.

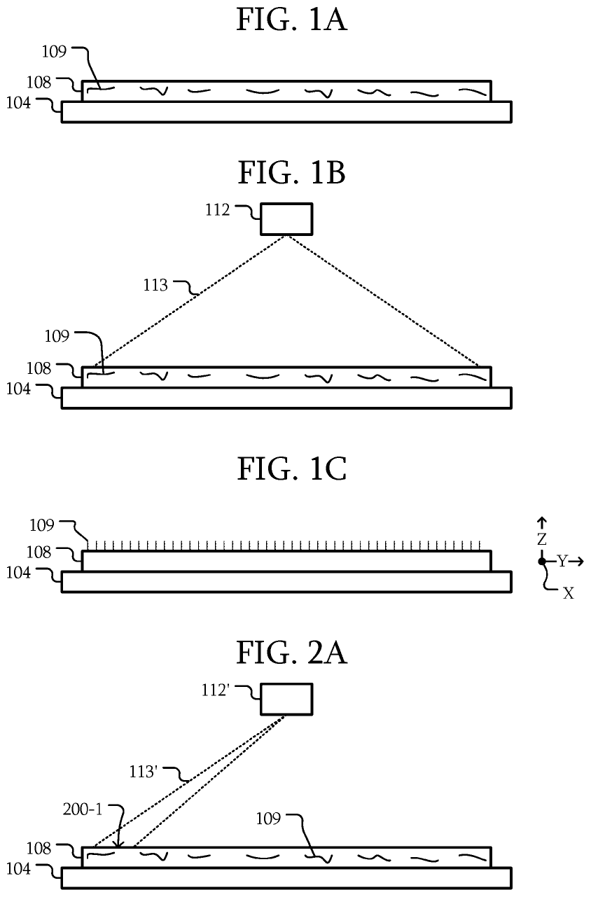

FIGS. 1A-1C are block diagrams of operations to form an activated nanotube substrate according to some embodiments. Referring to FIG. 1A, a substrate 104 including a nanotube layer 108 is provided. The substrate 104 may include a variety of materials. For example, the substrate 104 may include a metalized ceramic where the metallization layer might include copper, silver-palladium, molybdenum, molybdenum-manganese alloys, copper-titanium alloys, copper-silver alloys, copper-silver-titanium alloys, or the like and the ceramic layer might include aluminum oxide, silicon oxide, titanium nitride, MACOR, or other dielectrics. Any material to which the nanotube layer 108 may adhere to before the further processing described herein may be used as the substrate 104.

The nanotube layer 108 includes nanotubes 109. The nanotubes 109 may include carbon nanotubes; however, in some embodiments, the nanotubes 109 may include different materials. The nanotube layer 108 may additionally include materials, such as an adhesive, that will be described in further detail below that may react with applied energy. In some embodiments, the nanotube layer 108 is a single layer of nanotubes; however, in other embodiments, the nanotube layer 108 includes multiple laminated layers, each including nanotubes 109. For example, the nanotubes 109 may be disposed 10, 100, 1000, or more layers in the nanotube layer 108.

Referring to FIG. 1B, the nanotube layer 108 is heated. In this example, an energy source 112 directs energy (or power) 113 towards the nanotube layer 108. The energy 113 heats the nanotube layer 108. Examples of the energy source 112 include light amplification by stimulated emission of radiation (laser), an electron source, an ion source, or the like.

Referring to FIG. 1C, as a result of the heating of the nanotube layer 108, at least part of the nanotube layer 108 is disrupted and partially separated from the substrate. The disruption and partial separation (or partial ablation) moves the nanotubes 109 such that at least some nanotubes 109 are activated for electron emission. The activation for electron emission includes configuring the nanotubes 109 such that the nanotubes 109 are in an orientation that is not parallel to the substrate 104. The nanotubes 109 that are activated have a substantially non-parallel orientation. In an example, substantially non-parallel is more than 5° from parallel (355° to 5°) or 10° from parallel (350° to 10°) or 20°from parallel (340° to 20°). The nanotubes 109 that are activated may be partially adhered to the substrate 104. The activation may include configuring the nanotubes 109 such that when an electric potential is applied between a field emission gate (described in further detail below) and the substrate 104 or other surface electrically connected to the nanotubes 109, electrons are emitted from the nanotubes 109. Because the nanotubes 109 are partially adhered and oriented a few degrees away from parallel to the substrate 104, the nanotubes 109 may be in a state to reorient to approach or become substantially perpendicular to the substrate 104 when an electric field in applied. The adhesion of the nanotubes 109 to the substrate 104 may be greater than a force applied by an applied electric field. In an example, substantially perpendicular is 10° from perpendicular (80° to 100°) or 20° from perpendicular (70° to 110°).

The heating illustrated in FIG. 1B is local heating of the nanotube layer 108. That is, the substrate 104 is not directly heated. Energy may be transferred to the substrate 104, but the energy 113 is applied to the nanotube layer 108.

In some embodiments, the nanotube layer 108 may include loosely bonded or non-covalently bonded materials remaining from the deposition process. For example, depositing the nanotube layer 108 by way of an ink or paste may result in the nanotube layer 108 including these materials. In some embodiments, the nanotube layer 108 may be deposited on the substrate 104 by screen printing, ink jet printing, spray coating, or other processes. In some embodiments, the nanotube layer 108 may be deposited using a wet chemical process. The nanotube layer 108 may be dried. However, materials from the deposition process may still remain in the nanotube layer 108 to react with the energy 113. Some of the materials may be from preparation of the nanotubes 109 before the deposition, but the materials remain after the deposition.

In some embodiments, the materials include water (H2O), chlorine (Cl), sulfur (S), oxygen (O₂), superacids, such as chlorosulfonic acid (HSO₃Cl) and oleum (sulfur trioxide in sulfuric acid, disulfuric acid, or pyrosulfuric acid), methanesulfonic acid (MsOH or CH3SO₃H),, or the like. These materials in the nanotube layer 108 may react with the energy 113 to expand, vaporize, outgas, blister, or be otherwise agitated or expelled to disrupt the nanotube layer 108. The disruption of the nanotube layer 108 may result in the nanotubes 109 being no longer parallel to the substrate 104 and partially adhered to the substrate 104.

Before activation, the nanotubes 109 may be intertwined with each other and the materials in the nanotube layer 108. The nanotubes 109 are not suitable in this state to emit electrons. That is, the nanotubes 109 do not induce local enhancement of the electric field because no part of them is partially free from the adhesive and protruding out from the substrate 104.

In some embodiments, the remaining materials from the deposition of the nanotube layer 108, such as the water and acids listed above, may not need to be removed by a separate process. That is, the application of the energy 113 may also remove the materials.

In some embodiments, non-local heating of the nanotube layer 108 may not result in a suitable disruption to cause activation of the nanotubes 109. Non-local heating may not supply a sufficient amount of energy over time or power to the materials in the nanotube layer 108 to cause the disruption. In some embodiments, a power flux density that may result in activation of the nanotubes 109 may be greater than about a threshold amount of watts per square meter (W/m²), energy flux over a period of time, or the like. In some embodiments, an energy flux may be about less than 500 millijoules per square centimeter (mJ/cm²), about 10 to 300 mJ/cm 2 , 20 to 200 mJ/cm², or the like. The energy may be supplied over a time of about 1-20 nanoseconds (ns), greater than about 10 ns, greater than about 20 ns, or the like. A particular example includes about 48 mJ/cm² applied for about 7 ns. In some embodiments a power flux density may be greater than 5000 watts per square millimeter (W/mm2). For example, some embodiments may include a laser with a beam radius of about 25 micrometers (um), a square wave pulse duration of 20 nanoseconds (ns), and uniform intensity with pulse power of about 490 watts (W). In other embodiments, a higher power laser may be pulsed for a shorter period of time and/or moved at a faster rate. Alternatively, a lower power laser may be pulsed for a longer period of time and/or moved at a slower rate. In some embodiments, the energy may be delivered to the nanotube layer 108 within a certain time window such as less than 10 ns. If the energy delivered is above an ablation threshold (about 100-200 mJ/cm2), the nanotubes 109 in the nanotube layer 108 may burn up. If the energy is below that range, the nanotubes 109 may not burn up, but instead may thermally expand and become disrupted.

In some embodiments, the nanotube layer 108 may be unsuitable for typical methods of activating the nanotube layer 108. That is, the nanotube layer 108 may be configured such that the use of adhesive tape removal, rubber rollers, or other adhesives may not be effective to activate the nanotubes 109 because of the particular deposition process that formed the nanotube layer 108.

In some embodiments, the nanotube layer 108 may include mostly nanotubes 109 with the materials remaining from the deposition process (referred to as intrinsic nanotubes). The nanotube layer 108 may not have loose layers that may separate and lift off with an adhesive tape. In some embodiments, the chemical process used to mix and deposit the nanotube layer 108 on the substrate 104 may result in a single layer or multiple layers on the substrate 104. For example, the nanotube layer 108 up to 60 layers. The layers may be about 2 microns (μm). An adhesive tape may remove the entire nanotube layer 108, leave behind the adhesive without removing material, or the like, which may not result in suitably activated nanotubes 109.

In some embodiments, the nanotube layer 108 may be deposited in a manner that is suitable for activation by techniques using adhesive tape removal, rubber rollers, or other adhesives. However, such techniques are not used as the energy 113 applied may activate the nanotubes 109. That, is the application of the energy 113 may replace the techniques using adhesive tape removal, rubber rollers, or other adhesives.

In some embodiments, the activation using the energy 113 is a non-contact technique. The use of the energy 113 may not leave a residue on the nanotubes 109 or the remaining nanotube layer 108 that the use of adhesive tape may leave. The activation using the energy 113 may not compress the nanotubes 109 or the remaining nanotube layer 108 in a manner similar to a rubber roller.

In some embodiment, the process has advantages over other techniques of activating nanotubes. For example, abrasive particles that are significantly larger than the thickness of the nanotube layer 108 may be used to roughen the nanotube layer 108. However, the process may leave particles that must be removed by further processing. Scratching the surface with a needle, such as a micro to nano sized or atomic force microscopy (AFM) tip, or other device (with or without an electric field) may fracture the surface, but may need to be regularly sharpened. The use of the energy 113 to heat the nanotube layer 108 may not have these drawbacks.

In some embodiments, nanotubes 109 may separate from the nanotube layer 108 due to the energy 113. These nanotubes 109 may be redeposited on other regions such as outside of the nanotube layer 108 or on portions of the nanotube layer 108 that is not intended to be activated. In some embodiments, the separated nanotubes 109 may be collected. For example, a mask may be used to collect the separated nanotubes 109. As a result, redeposited nanotubes 109 may be redeposited in desired areas.

In some embodiments, the nanotube layer 108 may be actively or passively cooled after the heating by the energy 113 described above. The nanotube layer 108 may be passively cooled by the ambient processing temperature or environment. The nanotube layer 108 may be actively cooled such that the nanotube layer 108 is cooled faster than in an ambient environment. For example, the nanotube layer 108 may be cooled with a refrigerated gas, air, or the like.

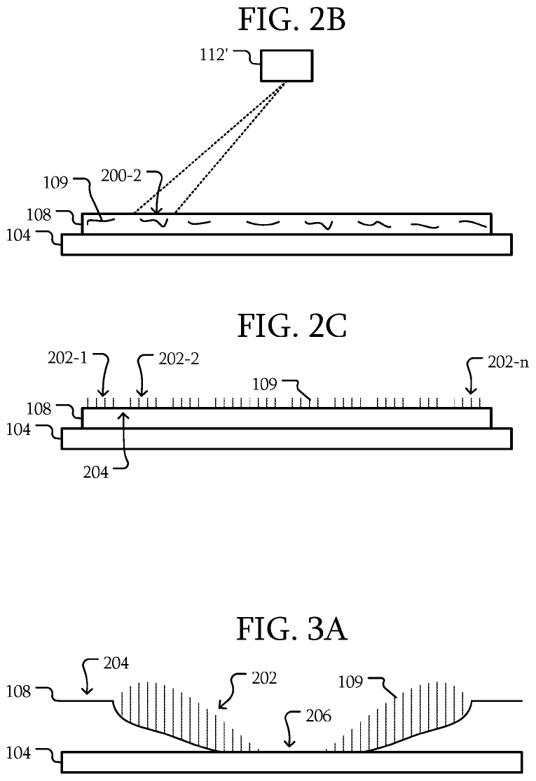

FIGS. 2A-2C are block diagrams of operations to form an activated nanotube substrate with activated regions according to some embodiments. An activated region 202 refers to portions of the nanotube layer 108 where electrons (with an applied voltage) can be substantially emitted from nanotubes 109 or the nanotubes 109 are activated for emission of electrons. An unactivated region 204 refers to portions of the nanotube layer 108 where no substantial emission of electrons is generated from nanotubes 109 (with an applied voltage) or the nanotubes 109 are not activated or unactivated for emission of electrons. In some embodiments, the energy source 112′ may be similar to the energy source 112 described above. However, the energy source 112′ may be configured to direct the energy 113′ (e.g., the energy beam). For example, a laser, ion beam, electron beam, or the like may be focused to a region 200 smaller than the entire surface of the nanotube layer 108.

Referring to FIG. 2A, the energy 113′ may be focused on a region 200-1 that is less than all of the nanotube layer 108. Referring to FIG. 2B, the energy 113′ may be directed to a different region 200-2. The energy 113′ may be scanned across the nanotube layer 108.

Referring to FIG. 2C, the energy 113′ may result in groups 202 of nanotubes 109. Here, groups 202-1 to 202-n are illustrated; however, any number of groups 202 of nanotubes 109 may be created by the energy 113′.

In some embodiments, the energy 113′ is pulsed by the energy source 112′ as the energy 113′ direction changes across the nanotube layer 108. The pulsing may result in discrete groups 202. While the creation of groups 202 may be a result of using energy 113′, in other embodiments, the energy 113′ may result in a continuous region 202 of nanotubes 109. For example, in some embodiments, the energy 113′ may be scanned continuously across the nanotube layer 108. In other embodiments, the regions 200 where the energy 113′ is directed may overlap across the nanotube layer 108. For example, a laser spot may have a non-uniform power distribution, such as a gaussian distribution. An overlap of the scanning of the energy 113′ may be based on the non-uniform power distribution such that the disruption occurs in the desired regions of the nanotube layer 108

In some embodiments, less than all of the nanotube layer 108 may be locally heated by the energy 113′. As a result, least some of the nanotube layer 108 may not include nanotubes 109 that are activated for electron emission after at least part of the nanotube layer 108 is disrupted due to the heating. However, in other embodiments, all of the nanotube layer 108 may be heated by the energy 113′.

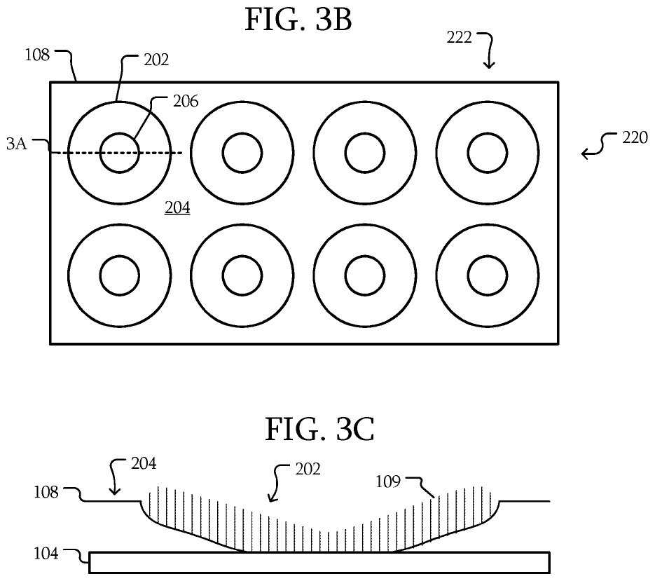

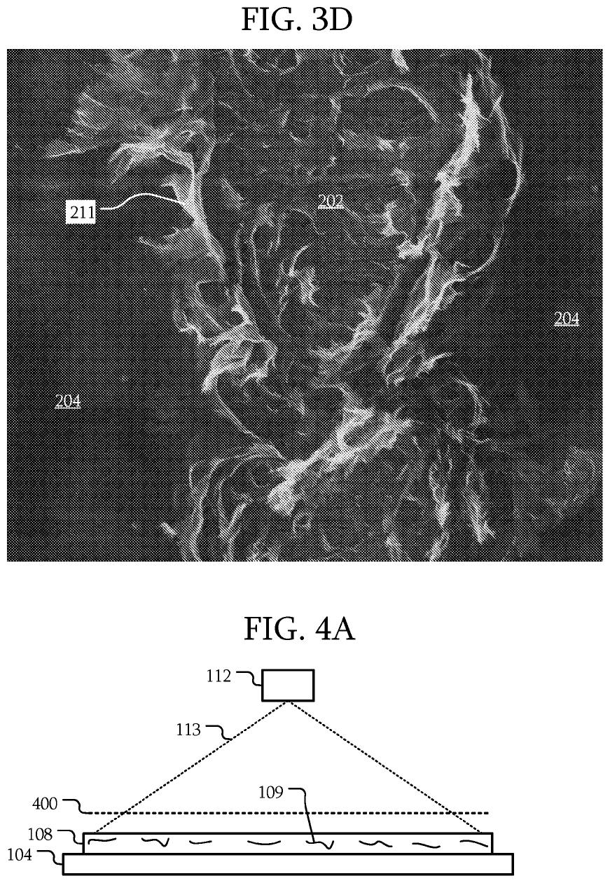

FIG. 3A-3C are block diagrams of activated regions on an activated nanotube substrate according to some embodiments. Referring to FIGS. 3A and 3B, in some embodiments., a region 200 includes nanotubes 109 that extend from remaining portions of the nanotube layer 108. FIG. 3A is a cross-section along line 3A of FIG. 3B. In region 202, the nanotubes 109 were activated. Outside of the region 202, a region 204 may include some of the nanotube layer 108 that was not activated, disrupted, or the like. In some embodiments, an power flux density of the energy 113′ is great enough to disrupt or ablate the nanotube layer 108 sufficiently to expose the substrate 104 in region 206. In some embodiments, an amount of the substrate 104 exposed in regions 206 may be less than about 25% of the area of the nanotube layer 108. In some embodiments the energy flux of the energy 113′ may be adjusted to adjust the exposure of the regions 206 or even the presence of exposed regions 206. In some embodiments, the amount of the exposed regions 206 may be adjusted based on a desired adhesion of the nanotube layer 108 to the substrate 104. The regions 206 may be regions where electrons are not emitted, as no nanotubes 109 are present.

The regions 202 may be disposed in rows 220 and columns 222. The region 204 may be disposed between these rows 220 and columns 222. Although a regular pattern of regions 202 in regular rows 220 and columns 222 is used as an example, the rows 220 and/or the columns 222 and the locations of the regions 202 may be irregular. In addition, while a circle has been used as an example of a shape of the regions 202, in other embodiments the shape may be different, the shape may vary across the nanotube layer 108, or the like.

Referring to FIG. 3C, in some embodiments, the energy 113′ may be controlled so that no regions 206 of the substrate 104 are exposed for an activation area. In addition, the energy 113′ may be controlled to control the depth of penetration of the energy 113′. As a result, some of the non-disrupted nanotube layer 108 may remain under region 202, including under the entire region 202. In some embodiments, the energy 113′ may be controlled to maximize the amount of nanotubes 109 activated and available for emission.

In some embodiments, the energy 113′ may be determined based on a thickness of the nanotube layer 108. In an embodiment, the thickness of the nanotube layer 108 may be between 100 nanometers (nm) to 5 μm. For example, a thinner nanotube layer 108 with a thickness from about 100 nanometers (nm) to about 300 nm, a lower energy 113′ of the energy source 112′ may be used. A thicker nanotube layer 108 with a thickness from about 500 nm to about 600 nm may be used to balance a higher energy 113′ of the energy source 112′, allow for greater resilience to variation in the energy 113′, or the like. In some embodiments the thickness of the nanotube layer 108 may be less than about 5 μm. For example, with a thicker nanotube layer 108, the thickness may vary across the surface with less uniformity. As a result, an effective energy flux from the energy 113′ may be different for different portions of the nanotube layer 108. In addition, the increased thickness may increase electrical resistance to electron flow from the metallized substrate to the nanotubes 109, increase processing time, or the like.

FIG. 3D is an image of nanotubes on a substrate according to some embodiments. Referring to FIGS. 3C and 3D, in some embodiments, the nanotubes 109 in region 202 are disposed in plates, planes, or other planar structures 211 of nanotubes 109. The planar structures 211 may extend away from the substrate 104.

In some embodiments, the region 202 may have multiple delaminated layers due to the disruption of the nanotube layer 108. The delaminated layers are at least partially attached to the substrate 104. The planar structure 211 of FIG. 3D is an example of such delaminated layers.

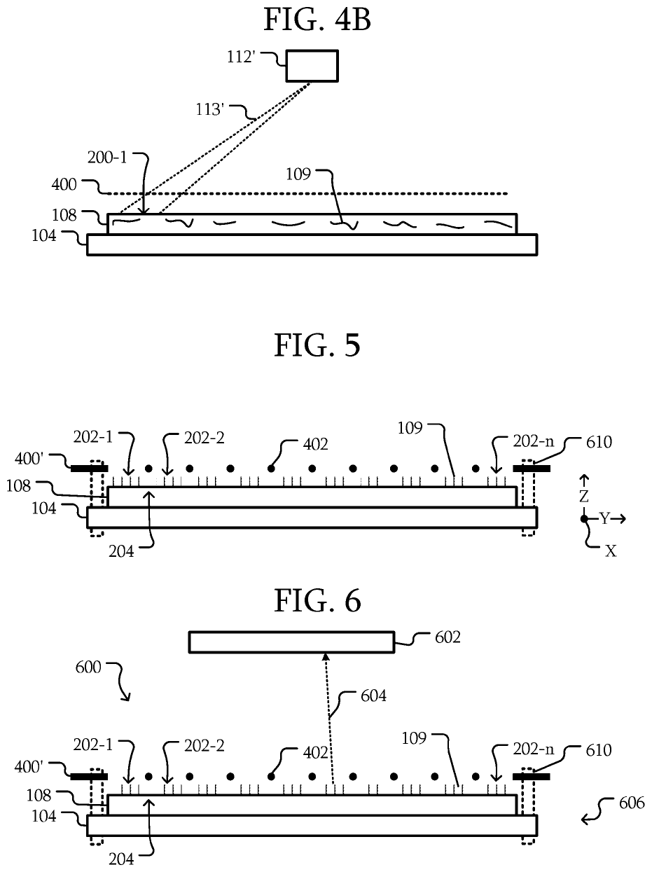

FIGS. 4A-4B are block diagrams of operations to form an activated nanotube substrate formed using a mask according to some embodiments. In some embodiments the process may be similar to that described above. However, a mask 400 may be used to filter the energy 113 or 113′. FIG. 4A is similar to FIG. 1B in that the nanotube layer 108 is heated with the energy 113 simultaneously while FIG. 4B is similar to FIG. 2A where the energy 113′ is scanned across the nanotube layer 108. In both cases, the energy 113 and the energy 113′ is partially blocked or scattered by the mask 400. As a result, the heating of the nanotube layer 108 may be performed through the mask 400. Differences between the regions 202 and 204 may be a result of the mask 400.

In some embodiments, the energy 113′ may be modulated as it is scanned across the nanotube layer 108. As a result, a pattern of energy that is incident on the nanotube layer 108 may be similar to the use of a mask 400, but a mask 400 may not be used to generate the pattern of energy that is incident on the nanotube layer 108.

FIG. 5 is a block diagram of a relationship of an activated nanotube substrate and a mask according to some embodiments. Referring to FIGS. 4A-5, in some embodiments, the mask 400 is a grid or gate that will be used as a field emission gate 400′ for a field emitter including the substrate 104 and nanotube layer 108 after processing. In other embodiments, the mask 400 has a structure substantially similar to a grid or gate that will be used as a field emission gate 400′ for a field emitter.

Here, a cross-section of the field emission gate 400′ is illustrated with individual rungs 402, wires, bars, or other structures extending along the nanotube layer 108. These structures will be collectively referred to as rungs 402. While rungs 402 extending in the X direction are illustrated, the rungs 402 may extend in different directions, such as the Y direction, in both the X and Y directions, or the like.

The nanotubes 109 are grouped in regions 202 divided by the rungs 402. That is, the field emission gate 400′ created a shadow on the nanotube layer 108. The regions under a shadow may not receive a sufficient power flux density to disrupt or otherwise activate the nanotubes 109. Thus, the regions 202 are separated from each other by regions 204 without nanotubes 109 that are activated. The regions 204 correspond on a one-to-one basis with the rungs 402. In some embodiments, the regions 204 may not correspond precisely to the rungs 402 in the X-Y plane. That is, the regions 204 may be offset from the rungs 402 in the X-Y plane due to the angle of the energy 113 or 113′ used to generate the regions 202. The regions 204 may be larger or smaller than the area defined by the rungs 402 or the mask 400.

FIG. 6 is a block diagram of an x-ray device with an activated nanotube substrate, a mask according to some embodiments. In some embodiments, the substrate 104 with the nanotubes 109 is installed in an x-ray device 600. A field emitter 606 includes the substrate 104, nanotube layer 108, nanotubes 109, and a field emission gate 400′. The field emission gate 400′ is disposed over the nanotubes 109 such that a potential between the field emission gate 400′ and the nanotubes may emit electrons 604 towards an anode 602. The anode 602 includes a material configured to generate x-rays in response to the incident electrons 604 such as tungsten (W), molybdenum (Mo), rhodium (Rh), silver (Ag), rhenium (Re), palladium (Pd), or the like.

In some embodiments, the field emission gate 400′ itself is the mask 400 described with respect to FIG. 4A or 4B that was used to create the regions 202 and 204. As a result, the regions 204 without nanotubes 109 that are activated are disposed beneath the rungs 402 of the field emission gate 400′. Electrons 604 will not be emitted from those unactivated regions 204. Electrons 604 would be emitted from activated regions 202, which are not covered by the rungs 402. Those electrons 604 activated regions 202 are less likely to impact and heat the rungs 402. Heating of the rungs 402 may cause the rungs 402 to bend out of plane, which may lead to a failure. Reducing the probability of heating reduces a probability of the related failure. By using the mask 400 as the field emission gate 400′, the field emission gate 400′ is self-aligned with the regions 204.

After the heating process, the field emission gate 400′ may be removed. The field emission gate 400′ and the emitter 606 may be cleaned. During the heating process, some nanotubes 109 may be detached from the nanotube layer 108 and deposited on the field emission gate 400′ or other surfaces, which can impair operational performance. The cleaning may remove those nanotubes 109.

The field emission gate 400′ may be reassembled with the emitter 606. The emitter 606 may include alignment structures 610 coupling the field emission gate 400′ to the emitter 606. For example, the alignment structure 610 may include a rod. The field emission gate 400′ and the emitter 606 may have openings through which the alignment structure 610 may be inserted. The alignment structure 610 may be present when the field emission gate 400′ was used as the mask 400. Thus, the field emission gate 400′ will be in the same position within the mechanical tolerances of the rod and the openings.

In some embodiments, the same mask 400 may not be used as the field emission gate 400′. However, the field emission gate 400′ may have the same structure as the mask 400 within mechanical tolerances. Thus, the rungs 402 of the field emission gate 400′ are aligned with the regions 204 without nanotubes 109 that are activated within mechanical tolerances.

Referring to FIG. 1A, in some embodiments, the nanotubes 109 may be activated without heating. For example. abrasive particles that are significantly larger than the thickness of the nanotube layer 108 may be used to roughen the nanotube layer 108. Scratching the surface with a needle, such as a micro to nano sized or atomic force microscopy (AFM) tip, or other device (with or without an electric field) may fracture the surface. These techniques or similar techniques may be used to abrasively contact the nanotube layer 108. The abrasive contact may activate the nanotubes 109 to be in the activated state as described above.

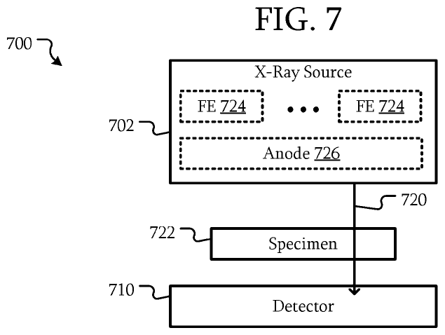

FIG. 7 is a block diagram of an x-ray imaging system according to some embodiments. The x-ray imaging system 700 includes an x-ray source 702 (also referred to as an x-ray device) and detector 710. The x-ray source 702 may include a substrate 104 with the nanotube layer 108 or the like as described above. In some embodiments, the x-ray source 702 includes multiple field emitters (FE) 724, each including a substrate 104 with the nanotube layer 108 or the like as described above. Electron beams from the field emitters 724 may be directed towards an anode 726 to generate x-rays 720. The x-ray source 702 is disposed relative to the detector 710 such that x-rays 720 may be generated to pass through a specimen 722 and detected by the detector 710. In some embodiments, the detector 710 is part of a medical imaging system. In other embodiments, the x-ray imaging system 700 may include a portable vehicle scanning system as part of a cargo scanning system, industrial inspection systems, or the like. The system 700 may be any system that may include an x-ray detector.

In some embodiments, the x-ray source 702 is used in different applications without a detector 710 (and does not providing imaging). For example, the x-ray source 702 may be used in radiation treatments such as radiation treatments for cancer, purifying materials, such as organic materials, like produce, food, blood, or the like using radiation, or other applications.

Some embodiments include a method, comprising: providing a substrate 104 including a nanotube layer 108 including nanotubes 109; heating the nanotube layer 108; and disrupting at least part of the nanotube layer 108 due to the heating such that nanotubes 109 in the at least part of the nanotube layer 108 are activated for electron emission.

In some embodiments, heating the nanotube layer 108 comprises locally heating the at least part of the nanotube layer 108.

In some embodiments, locally heating the at least part of the nanotube layer 108 comprises transferring energy to the at least part of the nanotube layer 108 at a rate of greater than 10 millijoules per square centimeter (mJ/cm²) over about 20 nanoseconds. In some embodiments, the rate is less than 500 mJ/cm² over 20 nanoseconds

In some embodiments, locally heating the at least part of the nanotube layer 108 comprises transferring energy to the at least part of the nanotube layer 108 at a rate of greater than 5000 watts per square millimeter (W/mm²).

In some embodiments, heating the nanotube layer 108 comprises locally heating less than all of the nanotube layer 108.

In some embodiments, heating the nanotube layer 108 comprises heating the nanotube layer 108 with at least one of a laser, an ion source, and an electron source.

In some embodiments, heating the nanotube layer 108 comprises scanning a energy source 112, 112′ (e.g., a heat source) across the nanotube layer 108.

In some embodiments, heating the nanotube layer 108 comprises pulsing the energy source 112, 112′ while scanning the energy source 112, 112′ across the nanotube layer 108.

In some embodiments, the method further comprises modulating the energy source 112, 112′ while scanning the energy source 112, 112′ across the nanotube layer 108

In some embodiments, after disrupting the at least part of the nanotube layer 108 due to the heating, at least some of the nanotube layer 108 includes no nanotubes 109 that are activated for electron emission.

In some embodiments, heating the nanotube layer 108 comprises heating the nanotube layer 108 through a mask 400, 400′.

In some embodiments, the method further comprises installing the substrate 104 in an x-ray device 702; wherein: the mask 400, 400′ is a field emission gate for a field emitter 724 including the nanotube layer 108.

In some embodiments, actively cooling the nanotube layer 108 after heating the nanotube layer 108.

Some embodiments include an x-ray device 702, comprising: an anode 726 configured to generate x-rays in response to incident electrons; and a field emitter 724 configured to emit electrons towards the anode 726, the field emitter 724 comprising a substrate 104 including a nanotube layer 108 including nanotubes 109 activated for electron emission; wherein the nanotubes 109 activated for electron emission were activated by: heating the nanotube layer 108; and disrupting at least part of the nanotube layer 108 due to the heating such that nanotubes 109 in the at least part of the nanotube layer 108 are activated for electron emission.

In some embodiments, the nanotube layer 108 includes regions of nanotubes 109 that were not activated for electron emission.

In some embodiments, the field emitter 724 further comprises a field emission gate 400′ configured to control emission of electrons from the at least part of the nanotube layer 108 activated for electron emission; and a structure of the field emission gate 400′ overlaps regions of the nanotube layer 108 including nanotubes 109 that were not activated for electron emission and includes openings corresponding to the nanotubes 109 in the at least part of the nanotube layer 108 that are activated for electron emission.

In some embodiments, the field emission gate 400′ is self-aligned with the regions of the nanotube layer 108 including nanotubes 109 that were not activated for electron emission.

In some embodiments, the nanotube layer 108 includes a single layer.

In some embodiments, the nanotube layer 108 includes non-covalently bonded materials.

In some embodiments, the nanotube layer 108 includes materials resulting from the process of depositing the nanotubes 109 on the substrate 104 in addition to the nanotubes 109.

Some embodiments include an x-ray device, comprising: means for supporting a nanotube layer 108 including nanotubes 109; means for heating the nanotube layer 108; and means for disrupting at least part of the nanotube layer 108 due to the heating such that nanotubes 109 in the at least part of the nanotube layer 108 are activated for electron emission.

In some embodiments, the x-ray device further comprises means for masking 400, 400′ the heating of the nanotube layer 108.

Some embodiments include a method, comprising: providing a substrate 104 including a nanotube layer 108 including nanotubes 109; abrasively contacting the nanotube layer 108 such that at least some of the nanotubes 109 in of the nanotube layer 108 are activated for electron emission.

Some embodiments include an x-ray device 702, comprising: an anode 726 configured to generate x-rays in response to incident electrons; and a field emitter 724 configured to emit electrons towards the anode 726, the field emitter 724 comprising a substrate 104 including a nanotube layer 108 including nanotubes 109 activated for electron emission; wherein the nanotubes 109 activated for electron emission are disposed in a plurality of activated regions of the nanotube layer 108 across the substrate 104 separated by unactivated regions of the nanotube layer 108 without activated nanotubes 109.

In some embodiments, the activated regions including the nanotubes 109 activated for electron emission include at least a partially delaminated layer (or partially attached planar structure) of the nanotube layer 108.

In some embodiments, the partially delaminated layer is thinner than the nanotube layer 108.

In some embodiments, the partially delaminated layer has a substantially non-parallel orientation relative to the plane formed by the nanotube layer 108.

In some embodiments, the partially delaminated layer has a substantially perpendicular orientation relative to the plane formed by the nanotube layer 108 when an emission voltage is applied.

In some embodiments, a plurality of partially delaminated layers has a substantially ellipsoidal orientation in at least one axis.

In some embodiments, the regions including the nanotubes 109 activated for electron emission are substantially ellipsoidal.

Some embodiments include an x-ray device 702, comprising: an anode 726 configured to generate x-rays in response to incident electrons; and a field emitter 724 configured to emit electrons towards the anode 726, the field emitter 724 comprising a substrate 104 including a nanotube layer 108 including nanotubes 109 activated for electron emission; wherein the nanotubes 109 activated for electron emission are disposed in a plurality of planar structures extending away from the substrate 104.

In some embodiments, the activated regions including the nanotubes 109 activated for electron emission include at least a partially delaminated layer (or partially attached planar structure) of the nanotube layer 108.

In some embodiments, the partially delaminated layer is thinner than the nanotube layer 108.

In some embodiments, the partially delaminated layer has a substantially non-parallel orientation relative to the plane formed by the nanotube layer 108.

In some embodiments, the partially delaminated layer has a substantially perpendicular orientation relative to the plane formed by the nanotube layer 108 when an emission voltage is applied.

In some embodiments, a plurality of partially delaminated layers has a substantially ellipsoidal orientation in at least one axis.

In some embodiments, the regions including the nanotubes 109 activated for electron emission are substantially ellipsoidal.

Some embodiments include an x-ray device 702, comprising: an anode 726 configured to generate x-rays in response to incident electrons; and a field emitter 724 configured to emit electrons towards the anode 726, the field emitter 724 comprising a substrate 104 including a nanotube layer 108 including nanotubes 109 activated for electron emission; wherein the nanotubes 109 activated for electron emission are disposed in a plurality of delaminated layers partially attached to the substrate 104.

Although the structures, devices, methods, and systems have been described in accordance with particular embodiments, one of ordinary skill in the art will readily recognize that many variations to the particular embodiments are possible, and any variations should therefore be considered to be within the spirit and scope disclosed herein. Accordingly, many modifications may be made by one of ordinary skill in the art without departing from the spirit and scope of the appended claims.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description. These additional embodiments are determined by replacing the dependency of a given dependent claim with the phrase “any of the claims beginning with claim [x] and ending with the claim that immediately precedes this one,” where the bracketed term “[x]” is replaced with the number of the most recently recited independent claim. For example, for the first claim set that begins with independent claim 1, claim 4 can depend from either of claims 1 and 3, with these separate dependencies yielding two distinct embodiments; claim 5 can depend from any one of claims 1, 3, or 4, with these separate dependencies yielding three distinct embodiments; claim 6 can depend from any one of claims 1, 3, 4, or 5, with these separate dependencies yielding four distinct embodiments; and so on.

Recitation in the claims of the term “first” with respect to a feature or element does not necessarily imply the existence of a second or additional such feature or element. Embodiments of the invention in which an exclusive property or privilege is claimed are defined as follows.

1. A method comprising:
providing a substrate including a nanotube layer including nanotubes;
heating the nanotube layer; and
disrupting at least part of the nanotube layer due to the heating such that the nanotubes in the at least part of the nanotube layer are activated for electron emission.

2. The method of claim 1, wherein:
heating the nanotube layer comprises locally heating the at least part of the nanotube layer.

3. The method of claim 2, wherein:
locally heating the at least part of the nanotube layer comprises transferring energy to the at least part of the nanotube layer at a rate of less than 500 millijoules per square centimeter (mJ/cm²) over 20 nanoseconds.

4. The method of claim 2, wherein:
locally heating the at least part of the nanotube layer comprises transferring energy to the at least part of the nanotube layer at a rate of greater than greater than 5000 watts per square millimeter (W/mm²).

5. (canceled)

6. The method of claim 1, wherein:
heating the nanotube layer comprises heating the nanotube layer with at least one of a laser, an ion source, or an electron source.

7. The method of claim 1, wherein:
heating the nanotube layer comprises scanning a heat source across the nanotube layer.

8. The method of claim 7, wherein:
heating the nanotube layer comprises pulsing the heat source while scanning the heat source across the nanotube layer.

9. (canceled)

10. The method of claim 1, wherein:
after disrupting the at least part of the nanotube layer due to the heating, at least some of the nanotube layer is free from the nanotubes that are activated for electron emission.

11. The method of claim 1, wherein:
heating the nanotube layer comprises heating the nanotube layer through a mask.

12. The method of claim 11, further comprising:
installing the substrate in an x-ray device;
wherein:
the mask is a field emission gate for a field emitter including the nanotube layer.

13.-23. (canceled)

24. An x-ray device comprising:
an anode configured to generate x-rays in response to incident electrons; and
a field emitter configured to emit electrons towards the anode, the field emitter comprising a substrate including a nanotube layer including nanotubes activated for electron emission;
wherein the nanotubes activated for electron emission are disposed in a plurality of activated regions of the nanotube layer across the substrate separated by unactivated regions of the nanotube layer without activated nanotubes.

25. The x-ray device of claim 24, wherein:
the activated regions including the nanotubes activated for electron emission include at least a partially delaminated layer of the nanotube layer.

26. (canceled)

27. The x-ray device of claim 25, wherein:
the partially delaminated layer has a non-parallel orientation relative to a plane formed by the nanotube layer.

28. The x-ray device of claim 25, wherein:
the partially delaminated layer has perpendicular orientation relative to a plane formed by the nanotube layer when an emission voltage is applied.

29. The x-ray device of claim 25, wherein:
a plurality of the partially delaminated layers has ellipsoidal orientation in at least one axis.

30. (canceled)

31. An x-ray device comprising:
an anode configured to generate x-rays in response to incident electrons; and
a field emitter configured to emit electrons towards the anode, the field emitter comprising a substrate including a nanotube layer including nanotubes activated for electron emission;
wherein the nanotubes activated for electron emission are disposed in a plurality of planar structures extending away from the substrate.

32. The x-ray device of claim 31, wherein:
the planar structures including the nanotubes activated for electron emission include at least a partially detached planar structure of the nanotube layer.

33. The x-ray device of claim 32, wherein:
the partially detached planar structure is thinner than the nanotube layer.

34. The x-ray device of claim 32, wherein:
the partially detached planar structure has a non-parallel orientation relative to a plane formed by the nanotube layer.

35.-36. (canceled)

37. The x-ray device of claim 31, wherein:
the planar structures including the nanotubes activated for electron emission are ellipsoidal.

38. (canceled)
